(19) United States
(12) Patent Application Publication
(10) Pub. No.: US 2025/0100230 A1
(43) Pub. Date: Mar. 27, 2025

(54) Weld Seam, Method and Device for Connecting Plastics Films by Thermal Joining, and Use of a Blow-Forging Press

(71) Applicant: Fraunhofer-Gesellschaft zur Förderung der Angewandten Forschung e.V., München (DE)

(72) Inventor: Mathias Kott, Dresden (DE)

(21) Appl. No.: 18/728,084

(22) PCT Filed: Jan. 16, 2023
(86) PCT No.: PCT/EP2023/050820

§ 371 Date: Jul. 11, 2024

(30) Foreign Application Priority Data
Jan. 14, 2022 (EP) 22151636.2

(51) Int. Cl. B29C 65/38; B29C 65/00; B29L 31/00; B31B 70/64; B31B 155/00

(52) U.S. Cl. CPC B29C 65/38; B29C 66/21; B29C 66/4326; B29C 66/8511; B31B 70/642; B31B 70/645; B29L 2031/7128; B31B 2155/002; B31B 2155/003

(57) ABSTRACT

Weld seam, method and device for connecting plastic films (10) by thermal joining, wherein the plastic films (10) are connected between welding jaws (2, 4) along a weld seam (12). According to the invention, the device comprises a pair of unheated welding jaws (2, 4) between which the plastic films (10) are arranged parallel to each other for thermal joining. A device for impulse generation (30) applies an impact impulse to one of the welding jaws (2, 4) with a penetration time into the plastic films (10) of less than 10 ms with a first intensity (Fi1). The impact impulse acts on the plastic films (10), wherein a heating in the material caused by deformation is produced and the weld seam (12) is formed in an effective area of the welding jaws (2, 4); use of a blow-forging press.

### CROSS REFERENCE TO RELATED APPLICATIONS

This application is the U.S. national stage of International Application No. PCT/EP2023/050820, filed on 2023 Jan. 16. The international application claims the priority of EP 22151636.2 filed on 2022 Jan. 14; all applications are incorporated by reference herein in their entirety.

### BACKGROUND

The invention relates to a weld seam, a method and a device for connecting plastic films by thermal joining, wherein the plastic films are connected between welding jaws along a weld seam. The invention further relates to the use of a blow-forging press.

An important application for the thermal joining of plastic films is the production and sealing of plastic film packaging, e.g. tubular bags, wherein the process is also referred to as sealing or heat sealing. In addition to processes and devices for connecting plastic films by thermal joining using heated welding jaws, also known as sealing jaws, which melt parts of the plastic films, there are many efforts to do without heated welding jaws. There are two main reasons for this: packaging heat-sensitive goods without introducing additional heat energy, and reducing energy consumption in the process. The plastic film, the general term for the materials that can be used in the invention, can be monofilms that consist of only one plastic material, monofilm composites, composite films made of several different plastic materials with an aluminum barrier, compostable and water-soluble plastic films, and shrink films—all of which must be thermally meltable.

The thermal joining by means of ultrasonic, as known from the prior art, already makes heated welding jaws unnecessary. The required thermal effect is not initiated from the outside, but is caused in the films to be welded themselves by the heat development in the plastic material, based on the energy input from the ultrasonic vibrations. This effect is the basis for the ultrasonic sealing solutions described, for example, in the publications DE 699 26 758 T2, DE 10 2009 046 319 A1 and DE 10 2017 121 572 A1, in combination with heat sealing. However, the machine technology required for ultrasonic sealing and the generation of the ultrasonic are very complex, both in terms of the system technology and the energy input.

Other methods for processing plastic films, such as separating plastic films by means of an impact impulse using a film punch in accordance with the publication DE 10 2015 211 622 A1, are also not suitable for forming a weld seam and joining the plastic films to one another.

### SUMMARY

Weld seam, method and device for connecting plastic films (10) by thermal joining, wherein the plastic films (10) are connected between welding jaws (2, 4) along a weld seam (12). According to the invention, the device comprises a pair of unheated welding jaws (2, 4) between which the plastic films (10) are arranged parallel to each other for thermal joining. A device for impulse generation (30) applies an impact impulse to one of the welding jaws (2, 4) with a penetration time into the plastic films (10) of less than 10 ms with a first intensity (Fi1). The impact impulse acts on the plastic films (10), wherein a heating in the material caused by deformation is produced and the weld seam (12) is formed in an effective area of the welding jaws (2, 4); use of a blow-forging press.

### DETAILED DESCRIPTION

The object of the present invention is therefore to provide a welded seam for connecting plastic films, as well as a robust, uncomplicated process and a simple device for connecting plastic films by thermal joining, wherein the plastic films are connected between unheated welding jaws along a welded seam quickly, reliably and in an energy-saving manner. A further object of the invention is the use of a blow-forging press.

The task is solved by a welded seam for connecting plastic films, produced by thermal joining between welding jaws, wherein a material bond is produced between the plastic films involved. According to the invention, the thermal joining is defined in such a way that the plastic films are first squeezed or otherwise deformed, whereby the heat required to form the welded seam is generated in the plastic films and the plastic films melt together.

The plastic melted for the connection is limited to the area of the comparatively narrow weld seam, because the thermal joining between a pair of unheated welding jaws is carried out by an impact impulse on the plastic films arranged between the welding jaws, which are parallel when the plastic films are horizontally aligned or are above each other when the plastic films are horizontally aligned. The thermal joining is achieved by processes in the material itself, because it is only the impact impulse and the resulting deformation in the active zone where the impact impulse strikes that leads to rapid, short-term heating and the desired material bond.

A pair of unheated welding jaws is also present if one welding jaw works against an abutment with an expansion that is greater than the expansion of the weld seam. The abutment then forms the second welding jaw of the pair.

The impact impulse is a stroke movement of at least one of the welding jaws, which is substantially perpendicular to the film layer and directed towards the film layer. This stroke movement occurs with a duration of penetration (hereinafter referred to as penetration time) of at least one of the welding jaws into the plastic films of less than 10 ms. The impact impulse acts on the plastic films with at least a first intensity. It is preferably caused by a mechanical drive, alternatively by an electrical magnetic drive.

The width of the weld seam is preferably between half and twice the thickness of each of the plastic films. According to one embodiment or application of the invention, the weld seam is formed as a longitudinal seam that joins the plastic film in the area of opposing edges, where the two edges of a film web are superimposed and form the superimposed plastic films in the sense of the invention. The longitudinal seam forms a tubular film from the plastic film. The plastic films arranged on top of each other can therefore also be a single film that has been folded over. If, in addition, a weld seam is formed as at least one transverse seam in the tubular film formed in this way, which closes the tubular film at at least one end, preferably with a bottom seam, a tubular bag is produced. To close the tubular bag, the remaining opening is also provided with a transverse seam, usually a top seam.

In a favorable embodiment of the weld seam, the impact impulse acts on the plastic films with a second, higher intensity compared to the first intensity, whereby the weld seam is separated immediately after, practically simultaneously with the creation of the weld seam, and welded plastic films remain on both sides of a separation line. This means that, for example, a protrusion on the longitudinal seam can be separated or the transverse seam between two tubular bags can be separated. The separation is carried out mechanically by squeezing, and at the same time thermally by melting using the heating that is also used for joining.

A welded seam that is inserted into a heat-sensitive shrink film, which is also a plastic film, has proven to be particularly advantageous. Since the heat applied for thermal joining is limited to the welded seam, the joining zone in the narrowest sense, the heat-affected zone of the process does not exceed the joining zone, a high quality of the welded seam is achieved and the shrink film is not affected. It retains its full shrink properties and does not warp in the seam area, as is the case with conventional heat sealing.

Another advantageous alternative is a welded seam that is designed as at least one welded point, which in practice is formed by a large number of such welded points lined up next to each other, and which joins the plastic films. This means that any seam shape can be produced in a flexible manner, each consisting of a large number of welded points, without the need for correspondingly shaped welding jaws. In addition, a low pulse energy is sufficient for the small surface of the individual welding point, so that the system can be realized in a small size and without complex drives. However, the high flexibility is at the expense of efficiency.

The task is also solved by a process for connecting plastic films by thermal joining, wherein the plastic films are connected between unheated welding jaws along a weld seam. In any case, it is not necessary to heat the welding jaws, but rather disadvantageous, especially if the heating, an external heat supply, leads to a softening of the plastic films. Likewise, preheating of the plastic film is prohibited. Therefore, “unheated” means a temperature of the welding jaws and the plastic films that remains below the softening temperature of the plastic films. If the welding jaws or the plastic films are heated slightly for other reasons, this does not affect the method according to the invention and the welding jaws or the plastic films are considered to be unheated or not preheated in the sense of the invention. This is what distinguishes the present invention from the prior art, in particular, where the welding jaws have to be heated to or above the melting temperature of the plastic film to be welded.

According to the invention, thermal joining is defined in such a way that the plastic films are first squeezed or otherwise deformed, whereby the heat required to weld the plastic films together is generated in the plastic films and the plastic films melt together. For this purpose, an impact impulse, transmitted to the plastic films by at least one of the welding jaws, acts on the plastic films with at least a first intensity and the weld is formed. The impact impulse, a stroke movement of at least one of the welding jaws perpendicular to the film layer, with a penetration time into the plastic films, which is considered from the beginning of the deceleration of the tool, at least one of the welding jaws, until its standstill, of less than 10 ms (milliseconds). Preferably, the penetration time is less than 5 ms, particularly preferably less than 1 ms, and depending on the film thickness, 0.05 to 0.5 ms. To do this, either the tool, preferably at a speed of 1 to 5 m/s as the starting speed for the impact impulse, is dropped onto the plastic films and is braked to a stop during the penetration time.

In general, it has been shown that certain process times are necessary to generate a sufficiently high temperature, the melting temperature, for the penetration or penetration of the plastic films. For film thicknesses up to 2×100 μm (i.e. two films each 100 μm thick), a process time of 0.05 ms to 0.3 ms is necessary. The maximum process time at which the process according to the invention can still be carried out is 10 ms, wherein two plastic films with a thickness of up to 200 μm can be joined. The preferred initial speed of the tool before penetration into the film is 0.5 to 6 m/s, but at least about 0.1 m/s. The beginning of penetration is considered to be approx. 20% of the film thickness, as the roughness and the elastic range must be overcome beforehand.

It has also been shown that when the impact impulse is applied, an energy input of 1 to 30 J (joules) per 100 mm of seam length occurs for a film thickness of up to 2×100 μm, and a minimum of 0.1 J per 100 mm of weld seam for plastic films of 0.1 mm thickness. Plastic films with a thickness between 20 μm and 200 μm can be used for the method according to the invention. It is also possible to join more than two film layers, e.g. 4 layers on top of each other or parallel. This is important for layer jumps and the production of stand-up pouches.

The impact impulse is preferably caused by a mechanical or magnetic drive. As an alternative to the tool that falls directly onto the plastic film, the plastic films arranged on top of each other or parallel to each other are pressed against each other with a pre-tensioning force between a pair of welding jaws in a preliminary step, and in a second step the impact impulse acts as previously defined and described. In this way, the roughness of the tool surfaces and, above all, of the plastic films is partially compensated. In all cases, a temperature effect occurs in the weld zone, which leads to a local melting of the plastic during the penetration time and the mechanical stress that occurs during penetration, which is very short-lived at a correspondingly high deformation speed. Ultimately, it is only the deformation of the plastic films in the area of the weld seam to a sufficient, albeit small extent that leads to the development of heat for melting in this area of the joining zone.

Due to the very fast process, practically no heat is lost and, not least because of the low heat input, it does not spread in a detrimental way beyond the joining zone. The melting is thus limited to the effective zone, the joining zone. As a result, neither the environment is affected by unwanted heat input (e.g. the area around the weld seam in the film or a packaged product near the weld seam), nor does heat flow to the environment as an energy loss.

It is not necessary, and in fact it is disadvantageous, to carry out the process with preheated or prewarmed plastic films. Due to the rapid temperature increase during the impact impulse, the material temperature has hardly any influence, provided that it does not even lead to a disadvantageous softening of the material. If the material is too soft, the forming process that causes the heating in the material does not take place.

The same applies to the welding jaws, which do not have to be preheated or prewarmed, since the temperature required for welding is generated or induced in the plastic film itself in a very short time during the impact impulse. The heating and melting of the plastic films is therefore advantageously limited to an immediate active zone, in which the weld seam is formed as a joining zone, and a minimal contact time, in particular the penetration time explained in more detail above. The high deformation speed results in adiabatic heating of the plastic films in the active zone with minimal energy input, without heat exchange with the surrounding air and the adjacent areas of the plastic films. Only as much material of the plastic films is liquefied as is necessary for their connection in the weld seam. This also prevents liquid material from being pressed out of the joining zone and not participating in the joining process. The seam is very narrow, which not least leads to material savings. In addition, time is saved and the energy requirement and input are very low compared to known processes such as heat sealing.

Furthermore, such a narrow seam or such a narrow heat-affected zone cannot be achieved with known processes, in particular conventional heat-sealing processes, because the heat is dissipated too quickly, more heat is required and the heated and softened area of the plastic films would increase as a result.

When the impact impulse is transmitted, the speed of sound and an impulse time of less than 10 ms, preferably 5 ms, are assumed. For the steel/steel impulse, a time of 0.25 ms was calculated for the 10 cm distance. The impact impulse according to the invention achieves an effect comparable to that of ultrasonic sealing on comparable materials, but instead of a large number of low-amplitude impulses, only a single impulse is applied, the impact impulse according to the invention. In both processes, the use of ultrasonic and an impact impulse, the temperature increase required for thermal joining is achieved by a physical-chemical effect in the plastic from which the films to be joined are made. At the same time, the invention realizes further advantages, in particular the lack of heat input and thus—in the case of application to packaging—the thermal protection of the packaged goods. These advantages are also decisive for the use of ultrasonic sealing, but the invention does not require any complex system technology with ultrasonic generation and sonotrode. In the process according to the invention, the heating is also much more limited to the effective zone of the sealing impact than in ultrasonic sealing.

In a favorable embodiment of the method, the impact impulse is applied at a second intensity that is higher than the first intensity and is so great that, together with the thermal joining or immediately thereafter, the same impact impulse is used to separate the plastic films in and along the weld seam. The weld seam itself is thereby divided lengthwise.

The impact impulse is generated in particular by spring force, a drop weight or a mechanical drive. One possibility for the mechanical drive is to design it as a cam disk drive, with which particularly fast movements can be controlled without delay and with an exact amplitude. In particular, the spring force and the drop weight can be brought manually into the position where they generate force, so that the method according to the invention can be carried out without an external energy supply.

In the case of a vertical arrangement, the impact impulse is applied by the upper welding jaw or, alternatively, by both welding jaws acting against each other. In particular, when the welding jaws act against each other, they can also be used for a high-speed process, for example in a tubular bag machine, e.g. with 100 cycles per minute, and integrated into it. In this case, the welding jaws can be designed as rollers that also function as feed rollers, for example, which apply the pre-tensioning force Fᵥ, while the impulse force Fᵢ is transferred to the plastic films by striking the rollers.

The task is also solved by a device for connecting plastic films by thermal joining, wherein the plastic films are connected between welding jaws along a weld seam. According to the invention, thermal joining is defined in such a way that the plastic films are first squeezed or otherwise deformed, whereby the heat required for welding the plastic films is generated in the plastic films and the plastic films melt together.

For this purpose, the device comprises a pair of welding jaws, between which the plastic films are arranged one above the other in a horizontal orientation or generally parallel to one another during thermal joining. An impact impulse is applied to at least one of the welding jaws with at least a first intensity and acts on the plastic films so that thermal joining occurs at the same moment as a result of abrupt structural changes, a rapid deformation of the material. Subsequently, the weld is formed in an active area of the welding jaws that is elongated in the direction of the length of the weld seam to be produced (or a part thereof). The impact impulse is preferably caused by a drive device. According to an advantageous further development, a device is provided by which the welding jaws are pressed against each other by means of a prestressing force before the impact impulse is applied.

In the preferred embodiment, the pair of welding jaws consists of at least a first welding jaw with an active area having a profiled cross-section. It has also been found to be advantageous if the pair of welding jaws includes the second welding jaw with a flat active area or with a profiled cross-section.

In a first embodiment, the profiled cross-section is designed as a radius R1, preferably with R1=4 to 10 mm, at the active area that is in contact with the films to be welded during the welding process. Alternatively, the profiled cross-section is designed as a flat profile with a width a, preferably a=0.1 to 0.4 mm, bounded on both sides by two radii R2, preferably with R2=1 to 4 mm. It has generally been found to be advantageous to limit the profile of the active area by radii in order to avoid damage to the plastic film. According to a further alternative, the profiled cross-section is wedge-shaped with an angle α, preferably α=2 to 5°, measured against the flat active area of the second welding jaw, which is usually horizontal, but in any case at right angles to the direction of impact. The wedge tip of the wedge-shaped cross-section is designed as a radius R3, preferably with R3=1 to 4 mm.

In a favorable embodiment, the first and/or the second welding jaw is designed as a rolling tool for use in a continuous feed web running process. Alternatively, the first and/or second welding jaw is designed as a tool that pivots towards the active zone or as a tool that is temporarily, i.e. discontinuously, carried along with the web during the welding process, as is common and generally known for certain processing steps in web running processes. The device according to the invention is therefore suitable for installation in packaging systems, wherein established technology for heat sealing can also be replaced.

It has also been found to be advantageous if the pair of welding jaws is made of hardened steel with a ground surface. Furthermore, each of the welding jaws contains elements for fastening to the drive device.

The drive mechanism acts on the first welding jaw according to a first embodiment or on the first and second welding jaws according to a second embodiment. The drive mechanism for generating the impact impulse has a spring, a drop weight or a mechanical gear. According to an advantageous embodiment, the mechanical gear is a cam gear, the advantages of which have already been explained above. Furthermore, a magnetic drive is provided which directly drives the welding jaw or an associated stamp.

The task is also solved by using a blow-forging press as a drive device for a device as described above. In particular, pneumatic blow-forging presses are not only suitable for embossing metals, but also for marking plastics or similar products. Small blow-forging presses are also frequently used in the pharmaceutical industry to emboss medicine boxes. The desired impact force can be precisely set using a spring and, once adjusted, the same results are achieved with every stamping process in the same material. The pre-tensioning effect, which also plays a decisive role in one embodiment of the method according to the invention, allows the workpiece to be positioned precisely, preventing deformation. A clamping system allows different stamping tools such as machine stamps, machine type holders and stamping units to be clamped in these machines. An exemplary stamping press has a striking force of 6 kN.

Compared to established sealing methods such as heat contact sealing (previously known as hot sealing) or ultrasonic sealing, the method proposed with the invention offers the following advantages:
cold tools, adiabatic joining process,
can be used for heat-sensitive products,
very cost-effective and robust plant and tool technology,
purely mechanical and hand-operated solutions can be implemented (spring pre-tensioning, spring drive),
extremely short process time,
smallest seam widths realizable,
specific seam patterns can be achieved through the profile pattern of the tool's working area,
Joining or joining-separation combination can be realized with the same tool,
separate seam can be defined more precisely,
suitable for recyclable monofoils or monolaminates
standard packaging forms (sealed-edge bags, tubular bags) can be realized,
Very low energy requirement, therefore very high energy efficiency.

When joining a PP film with a film thickness of 20 to 100 μm and a standard seam length by heat sealing, also known as heat impulse joining, an electrically generated heat impulse of 0.8 seconds at 165° C. is required. This corresponds to an energy consumption of 200 J in a welding gun. In contrast, the energy requirement for joining using the method according to the invention is only 5 J for the same seam length. This corresponds to an energy saving of 97.5%.

The advantages mentioned above result in the following areas of application:

Packaging process with plastic films (technical products, food, medical products) for both high-speed series applications and individual processes in decentralized production
Use for continuous processes due to high process speed,
Use with recyclable and compostable films,
Applications for sealing without electrical energy using spring tension for mobile use, medical technology for development aid (sealing of medical samples on site), disaster relief (sealing of sandbags),
Packaging in dusty environments.

### BRIEF DESCRIPTION OF THE DRAWINGS

The invention is explained in more detail below, based on the description of examples of the design and their representation in the associated drawings. The following show:

FIG. 1: a schematic view of a process sequence of the method according to the invention for connecting plastic films by thermal joining;

FIG. 2: a schematic perspective view of an embodiment of a welding jaw according to the invention with an active area with a cross-section profiled as a radius;

FIG. 3: a schematic perspective view of an embodiment of a welding jaw according to the invention with an active area with a cross section profiled as a radius, limited by two radii;

FIG. 4: a schematic perspective view of an embodiment of a welding jaw according to the invention with an active area with a cross section profiled at a flat angle;

FIG. 5: a schematic perspective view of an embodiment of a first welding jaw according to the invention with an active area with a flat-profiled cross-section;

FIG. 6: a schematic perspective view of an embodiment of a second welding jaw according to the invention with a flat working area;

FIG. 7: a schematic view of an embodiment of a blow-forging press in two views;

FIG. 8: a schematic side view of an embodiment of a continuous web running process;

FIG. 9: a schematic view of a further embodiment of a continuous web running process;

FIG. 10: a schematic perspective view of an embodiment of a weld seam according to the invention on a film tube;

FIG. 11: a schematic perspective view of an embodiment of weld seams according to the invention on a tubular bag;

FIG. 12: a schematic side view of an embodiment of an apparatus according to the invention in a joining-separating combination and

FIG. 13: a schematic enlarged view of a joining-separating combination with joined plastic films and a separated area.

### DETAILED DESCRIPTION OF THE PREFERRED EMBODIMENTS

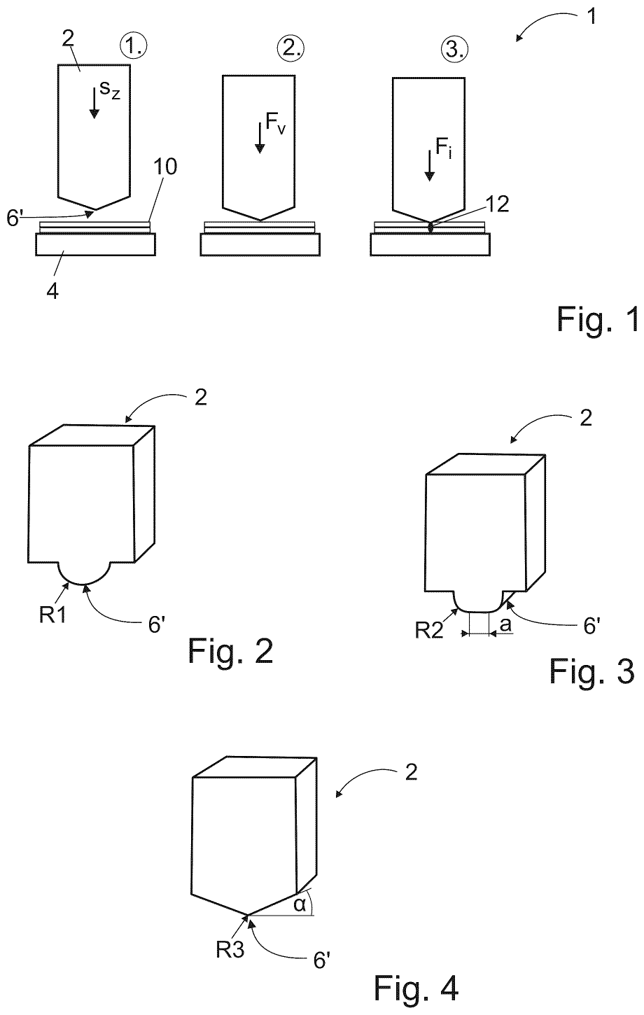

FIG. 1 shows a schematic view of a process sequence of the method according to the invention for connecting plastic films 10 by thermal joining. The process sequence is shown in three steps, starting from the left. First, a first welding jaw 2 is moved over the feed distance s_{z} to the surface of the plastic films 10 in the direction of the arrow until an active area 6, 6′ touches the plastic films 10. The two plastic films 10 to be joined by a weld seam are thereby lying on the surface of the second welding jaw 4.

In a second step, the first welding jaw 2 is pressed against the plastic films 10 with a pre-tensioning force Fᵥ. In the third step, the impulse force Fᵢ is applied under the pre-load created in this way, which leads to the formation of the weld 12.

In the embodiment of the method according to the invention shown, the plastic films 10 remain connected to each other in the area of the weld seam 12. However, by selecting a higher impulse force Fᵢ, the plastic films 10 can also be separated at the weld seam 12, so that two plastic films are present that are connected to each other by the weld seam 12, but are transversely separated in the area of the weld seam 12.

FIG. 2 shows a schematic perspective view of an embodiment of a first welding jaw 2 according to the invention, with a profiled cross-section designed as a radius R1, which forms a profiled active area 6′. For a film thickness of 70 μm, the preferred radius R1=4 to 10 mm, wherein a good material bond at the weld and a tight weld seam are achieved.

FIG. 3 shows a schematic perspective view of a design of a welding jaw 2 according to the invention with a flat profiled cross-section, limited by two radii R2, which forms an effective area 6. For a film thickness of 70 μm, the preferred radius R2=1 to 4 mm and the flat profile has a width a=0.1 to 0.5 mm.

FIG. 4 shows a schematic perspective view of a design of a welding jaw 2 according to the invention with a flat-angled profiled cross-section, which forms an effective area 6′. The tip of the angle has a radius R3. For a film thickness of 70 μm, the preferred radius R3=4 to 10 mm and the preferred angle α=2 to 5°.

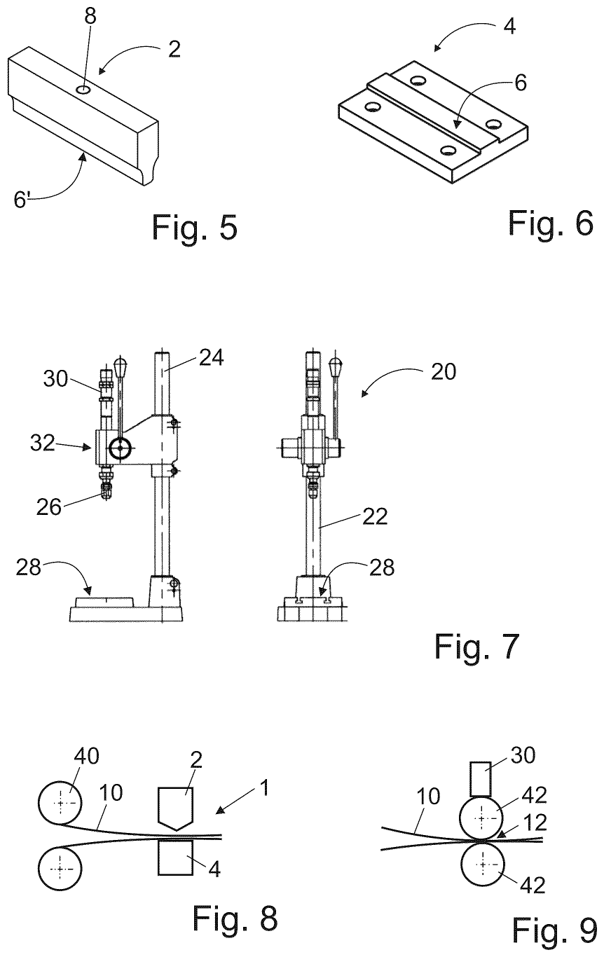

FIG. 5 shows a schematic perspective view of a design of a first welding jaw 2 according to the invention with an active area 6 with a flat cross-section. A mounting hole 8 is used to insert a clamping bolt, which is not shown here, with which the first welding jaw 2 is attached to a welding jaw holder 26 (see FIG. 7) of a machine that applies the pre-tensioning force Fᵥ and the impulse force Fᵢ to the first welding jaw 2.

FIG. 6 shows a schematic perspective view of a design of a second welding jaw 4 according to the invention with a flat active area 6. This is attached to a welding jaw holder 28 (see FIG. 7).

FIG. 7 shows a blow-forging press 20 in two views, which is used to carry out the sealing process according to the invention. It is particularly advantageous that such a blow-forging press 20 can be operated without electrical power and purely manually if it is designed as a spring-loaded blow-forging press according to the example shown. The force required for the feed movement over the feed distance s_{z}, as well as for the pre-tensioning force Fᵥ and the impulse force Fᵢ, is applied by the operator via an operating lever 24.

As shown in FIG. 1, the weld 12 is produced between the second welding jaw 4, on which the plastic films 10 rest, and the first welding jaw 2, which is fastened in a first welding jaw holder 26. To do this, the operating lever 24 is moved and the first welding jaw holder 26 is moved towards the second welding jaw holder 28 by means of a feed device 32 until the first welding jaw 2 inserted in the first welding jaw holder 26 touches the plastic films 10.

By further movement of the operating lever 24, the required pre-tensioning force Fᵥ is applied and, after continued movement of the operating lever 24, wherein a spring is tensioned, the impulse force Fᵢ is applied to the plastic films 10 by triggering the impulse generation 30. The weld 12 is thus produced in the area of an active zone between the first welding jaw 2 and the second welding jaw 4. The return stroke of the second welding jaw holder 26 and thus of the associated welding jaw by countermovement of the operating lever 24 leads to the release of the sealed, welded plastic films 10.

Depending on the desired result and the set level of the impulse force Fᵢ, the sealed plastic films 10 can be additionally and simultaneously separated in the area of the weld seam 12 and along the latter. This can be advantageous, for example, if a package, a tubular bag, is to be closed by the weld seam 12 and at the same time separated from a subsequent package.

FIG. 8 shows a schematic side view of a continuous web running process in which each of the plastic films 10 to be welded runs off a supply roll 40. In the device 1 for connecting plastic films 10 by thermal joining, the plastic films 10 pass between the first welding jaw 2 and the second welding jaw 4, where the weld seam 12 (not yet formed in the illustration) is produced. However, precautions must be taken to ensure the continuity of the web running process, even during the application of the prestressing force in particular, but also of the impact impulse. This can be realized, for example, by a cyclically synchronized movement of the device 1 or by a web buffer storage after the supply roll 40 and before the device 1.

FIG. 9 shows a further embodiment of a continuous web running process in a schematic side view. The prestressing force is applied by prestressing rollers 42, between which the plastic film 10 passes. A device for impulse generation 30, in particular a percussion gear, acts on one or both of the pre-tensioning rollers 42, so that the impact impulse is indirectly introduced into the plastic film 10 and the weld seam 12 is produced.

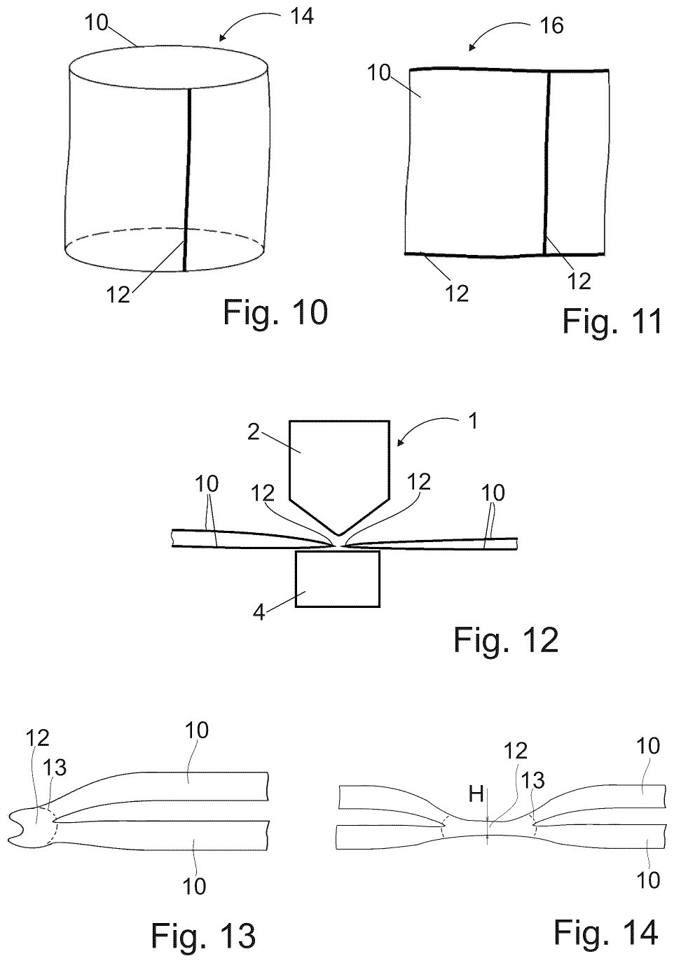

FIG. 10 shows a schematic perspective view of an embodiment of a weld seam 12 according to the invention on a film tube 14. This can advantageously be used as a sleeve packaging, wherein the film tube 14 is pushed over a package. It is particularly advantageous if the film tube 14 consists of a shrink film that shrinks when heated and fits tightly and smoothly as a shrink sleeve to the wrapped packaging.

The particular advantages of the method according to the invention become apparent in such an application, since the weld seam 12 does not impair the surrounding areas of the shrink film by heating. While in known welding processes the heat flow from the (also comparatively wide) weld into the surrounding plastic film leads to unsightly, undesirable and even after shrinking still visible deformations, especially wrinkling, and thus an aesthetically deficient result, the invention can avoid these disadvantages. The weld seam 12 is very narrow and, as explained above, avoids thermal impairment of the plastic film 10 adjacent to the weld seam 12, which remains smooth in the area of the weld seam 12 and also retains its full shrink capacity.

FIG. 11 shows a schematic perspective view of an embodiment of the weld seams 12 according to the invention on a tubular bag 16. This comprises a film tube 14, as shown in FIG. 10, which is sealed at both ends. This is usually done on the second side after filling with a packaged product. At the same time, the tubular bag 16, which is closed by a top seam, the upper weld seam 12, is separated from the film web by means of a joining-separating combination, while a further bottom seam, the lower weld seam 12 of the next tubular bag 16, is produced.

A shrink film can also be used for this application, in particular to wrap a box, wherein the wrapping lies tightly against the box after shrinking. Here too, the advantage is that an attractive appearance can be achieved by very narrow, clean and non-distorted weld seams 12.

FIG. 12 shows a schematic side view of a design of a device 1 according to the invention in a joining-separating combination, i.e. that immediately after the welding or practically at the same time, the plastic films 10 are separated directly in the center of the already very narrow weld 12. This is particularly clear in the enlarged view in FIG. 13. The device 1 comprises the welding jaws 2, 4, shown after the return stroke, which releases the joining and separating point.

FIG. 13 shows a schematic enlarged view of a joining-separation combination with joined plastic films 10 and a separated area where the part protruding beyond the weld 12 is separated within the weld 12. The very narrow weld 12 can be seen.

The material next to the weld 12 is not thickened, which already makes it clear that no excess material from the plastic films 10 is melted and displaced, as is the case with other prior-art heat-sealing processes. It can also be seen that the heat-affected zone 13, whose boundary with the unaffected plastic film 10 is shown by a dashed line, is limited to the weld 12, the joining zone, and leaves the surrounding areas of the plastic films 10 unaffected.

FIG. 14 shows a schematic enlarged view of a joint with joined plastic films 10, without separation at the weld 12, so that the plastic films 10 extend on both sides of the weld 12. The very low weld 12 with the height H at the joint zone, the fused plastic films 10, can also be seen. The material next to the weld 12 is also not thickened, which makes it clear that no excess material from the plastic films 10 is melted and displaced. Rather, the heat-affected zone 13 is confined to the area of the weld seam 12 and neither the plastic films 10 nor any area outside the plastic films 10, for example a heat-sensitive packaged product inside a package, is affected by unwanted heating.

### LIST OF REFERENCE NUMERALS

1 Device
2 First welding jaw
4 Second welding jaw
6, 6′ Effective area
8 Mounting hole
10 Plastic film
12 Weld seam, joining zone, longitudinal seam, transverse seam, weld spot
13 Heat-affected zone
14 Tubular film
16 Tubular bag
20 Blow-forging press
22 Stand
24 Operating lever
26 First welding jaw holder
28 Second welding jaw holder
30 (Device for) impulse generation
32 Feed device
40 Supply roll
42 Rolling tool, pre-tensioning roller
a Effective width
R1 First effective range radius
R2 Second effective range radius
R3 Third effective range radius
Fᵥ Preload force
Fᵢ Impact force, intensity of the impact
s_{z} Feed distance
H Height of joining zone (weld seam)

1. A weld seam for connecting plastic films (10), produced by thermal joining between welding jaws (2, 4), characterized in that an impact impulse, a stroke movement of at least one of the welding jaws (2, 4) perpendicular to the film layer, with a penetration time of at least one of the welding jaws (2, 4) into the plastic films (10) of less than 10 ms, acts on the unheated plastic films (10) arranged in parallel between a pair of unheated welding jaws (2, 4), the impact impulse having at least a first intensity (Fᵢ₁) by which the weld seam (12) is formed, the plastic melted by the impact impulse being restricted to the weld seam (12).

2. The weld seam according to claim 1, wherein the width thereof is between half and twice the thickness of each of the plastic films (10).

3. The weld seam according to claim 1, which is formed as a longitudinal seam (12) that connects the plastic film (10) in the area of opposing edges and forms a film tube (14) from the plastic film (10).

4. The weld seam according to claim 3, which is formed as at least one transverse seam (12) that closes the film tube at at least one end and produces a tubular bag (16).

5. The weld seam according to claim 3, wherein the impact impulse acts on the plastic films (10) with a second intensity (Fᵢ₂), whereby after the weld seam (12) has been produced, it is separated along a dividing line and welded plastic films (10) remain on both sides of the dividing line.

6. The weld seam according to claim 1, wherein a shrink film is used as the plastic film (10).

7. The weld seam according to claim 1, wherein the weld seam (12) is designed as at least one weld point (12) and a plurality of weld points (12) arranged in a row connect the plastic films (10).

8. A method for connecting plastic films (10) by thermal joining between welding jaws (2, 4), wherein the plastic films (10) are connected along a weld seam (12), characterized in that an impact impulse, a stroke movement of at least one of the welding jaws (2, 4) extending perpendicularly to the film layer, with a penetration duration of at least one of the welding jaws (2, 4) into the non-preheated plastic films (10) arranged parallel to one another, is shorter than 10 ms, acts on the plastic films (10) with at least a first intensity (Fᵢ₁), causes a heating in the material due to deformation and forms the weld seam (12).

9. The method according to claim 8, wherein in a step preceding the impact impulse, the plastic films (10) are pressed against each other between the pair of welding jaws (2, 4) with a pre-tensioning force Fᵥ and then the impact impulse acts on the plastic films (10) at least through one of the driven welding jaws (2, 4) or at least through one of the welding jaws (2, 4).

10. The method according to claim 8, wherein the impact impulse is effected with a second intensity (Fᵢ₂) instead of the first intensity (Fᵢ₁), wherein the second intensity (Fi2) is higher than the first intensity (Fᵢ₁), so that immediately after the joining, a separation of the plastic films (10) within and along the weld seam (12) occurs.

11. The method according to claim 8, wherein the mechanical drive of the welding jaws (2, 4) is effected directly or the indirectly transmitted impact impulse is effected by spring force, a drop weight, a magnetic drive or a cam disk drive.

12. The method according to claim 8, wherein the impact impulse is applied by the upper welding jaw (2) or by both welding jaws (2, 4) acting against each other

13. The method according to claim 12, wherein the welding jaws (2, 4) acting against each other are part of a continuous, high-speed process.

14. A device for connecting plastic films (10) by thermal joining, wherein the plastic films (10) are connected between welding jaws (2, 4) along a weld seam (12), characterized in that the device (1) comprises a pair of unheated welding jaws (2, 4) between which the unheated plastic films (10) are arranged parallel to each other for thermal joining, wherein a device for impulse generation (30) generates an impact impulse, a stroke movement of at least one of the welding jaws (2, 4) perpendicular to the film layers with a penetration time of at least one of the welding jaws (2, 4) into the plastic films (10) of less than 10 ms, having at least a first intensity (Fᵢ₁) into at least one of the welding jaws (2, 4), wherein the impact impulse acts on the plastic films (10), a heating in the material of the plastic films (10) caused by deformation is produced and the weld seam (12) is formed in an effective area of the welding jaws (2, 4).

15. The device according to claim 14, wherein the welding jaws (2, 4) are pressed against each other by means of a device for applying a prestressing force (Fᵥ) before the impact impulse is applied.

16. The device according to claim 14, wherein the pair of welding jaws (2, 4) consists of at least a first welding jaw (2) with an active area having a profiled cross-section (6′).

17. The device according to claim 16, wherein the pair of welding jaws (2, 4) comprises a second welding jaw (4) with a flat active area (6) or with a profiled cross section (6′), wherein the profiled cross-section (6′) is formed as a radius R1, or wherein the profiled cross-section (6′) is formed as a flat profile with a width a, which is limited by two radii R2 or wherein the profiled cross-section (6′) is wedge-shaped at an angle α to the flat effective area of the second weldinq jaw (4), the wedge tip of which is formed as a radius R3.

18. (canceled)

19. (canceled)

20. (canceled)

21. The device according to claim 14, wherein the pair of welding jaws (2, 4) is inserted into a high-speed, continuous web running process with continuous feed.

22. The device according to claim 21, wherein the first and/or the second welding jaw (2, 4) is designed as a rolling tool (42), as a tool that pivots towards the active zone or as a tool that is intermittently carried along with the web during the welding process.

23. (canceled)

24. (canceled)

25. The use of a blow-forging press (20) as a drive mechanism for a device according to claim 14.
